(19) United States
(12) Patent Application Publication
(10) Pub. No.: US 2007/0036429 A1
(43) Pub. Date: Feb. 15, 2007

(54) Method, apparatus, and program for object detection in digital image

(75) Inventor: Kensuke Terakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/500,928

(22) Filed: Aug. 9, 2006

(30) Foreign Application Priority Data
Aug. 9, 2005 (JP) 230495/2005

(51) Int. Cl. G06K 9/62; G06K 9/46; G06K 9/00

(52) U.S. Cl. 382/159; 382/190; 382/118

(57) ABSTRACT

In a method of detection of a predetermined object in an input image, one or more sample image groups representing the object of which a predetermined part or parts is/are occluded is/are prepared in addition to a sample image group representing the entirety of the object, by shifting a position at which sample images in the entirety sample image group are cut. A plurality of detectors are generated by causing the detectors to learn the respective types of the sample image groups according to a machine learning method. The detectors are applied to partial images cut sequentially from the input image at different positions, and judgment is made as to whether each of the partial images is an image representing the object in the state of the entirety or in the state of occlusion thereof.

### BACKGROUND OF THE INVENTION

1. Field of the Invention

The present invention relates to an object detection method and an object detection apparatus for detecting a predetermined object in a digital image. The present invention also relates to a program therefor.

2. Description of the Related Art

Various kinds of methods have been proposed for detecting a predetermined object such as a face in a digital image such as a general photograph by using a computer or the like. As a method of detection for such an object is known a method by template matching that has been used from comparatively early days. In addition is known a method using learning by so-called boosting that recently attracts attention (see U.S. Patent Application Publication No. 20020102024).

In a method using learning by boosting, a detector that can judge whether an image represents a predetermined object is prepared by causing the detector to learn characteristics of the predetermined object based on a plurality of sample images representing the predetermined object and a plurality of sample images that do not represent the predetermined object. Partial images are sequentially cut from a detection target image in which the predetermined object is to be detected, and the detector judges whether each of the partial images is an image representing the predetermined object. In this manner, the predetermined object is detected in the detection target image.

A method of this type is effective for solving a 2-class problem such as detection of face by judging whether an image represents a face or a non-face object. Especially, the method using learning by boosting can achieve fast and high-performance detection, and is used widely in various fields in addition to techniques similar thereto.

However, this method is based on an assumption that the entirety of an object to be detected appears in an image. Therefore, in the case where a part of an object is covered for some reason, the object is not appropriately detected. For example, in the case where an object to be detected is a human face, if a part of a face is occluded by hair, a hand, another subject, or the like, the face cannot be detected appropriately. Especially, in a method for detecting an object by using a detector that has been generated by learning adopting boosting, detection performance strongly depends on sample images used for the learning. Therefore, detection failure tends to occur.

### SUMMARY OF THE INVENTION

The present invention has been conceived based on consideration of the above circumstances. An object of the present invention is therefore to provide an object detection method and an object detection apparatus enabling appropriate detection of a predetermined object covered partially in a digital image, in addition to a program therefor.

An object detection method of the present invention is an object detection method for detecting a predetermined object in an input image, and the method comprises the steps of:

preparing a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;

cutting partial images in the predetermined sizes at different positions in the input image; and

judging whether each of the partial images is an image representing the entirety of the predetermined object or whether each of the partial images is an image representing the predetermined object of which the predetermined part is covered, by applying at least one of the plurality of detectors on each of the partial images as the detection target image.

An object detection apparatus of the present invention is an object detection apparatus for detecting a predetermined object in an input image, and the apparatus comprises:

a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;

partial image cutting means for cutting partial images in the predetermined sizes at different positions in the input image; and

judgment means for judging whether each of the partial images is an image representing the entirety of the predetermined object or whether each of the partial images is an image representing the predetermined object of which the predetermined part is covered, by applying at least one of the plurality of detectors on each of the partial images as the detection target image.

A program of the present invention is a program for detecting a predetermined object in an input image, and the program causes a computer to function as:

a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;

partial image cutting means for cutting partial images in the predetermined sizes at different positions in the input image; and

judgment means for judging whether each of the partial images is an image representing the entirety of the predetermined object or whether each of the partial images is an image representing the predetermined object of which the predetermined part is covered, by applying at least one of the plurality of detectors on each of the partial images as the detection target image.

In the present invention, the covered sample image group or groups is/are obtained by cutting each of the sample images in the entirety sample image group by a frame having the same size as the corresponding sample image at a position shifted by a predetermined length in a predetermined direction.

In this case, it is preferable for the predetermined direction to be either the horizontal or vertical direction of the sample images while it is preferable for the predetermined length to range from ⅓ to ⅕ of a width of the predetermined object.

In the present invention, the predetermined object may be a face including eyes, nose, and mouth, and the predetermined part may be a part of the eyes or the mouth.

In the present invention, the machine learning method may be a learning method using a neural network, a support vector machine, or boosting. However, it is preferable for the machine learning method to be a method using boosting.

The predetermined part in the predetermined object may be covered by an image representing some drawing or by an image without drawing such as an image painted completely in black or white.

According to the method, the apparatus, and the program of the present invention for object detection in a digital image, the detector whose detection target image is an image representing the entirety of the predetermined object (referred to as a first detector) and the detector or detectors whose detection target image is an image representing the partially covered predetermined object (referred to as a second detector) are used when judgment is made as to whether each of the partial images cut from the input image is the predetermined object. Therefore, the partially covered predetermined object that is difficult for the first detector to detect can be judged by the second detector. Consequently, the object that conventionally has not been detected can be detected appropriately even in the case where a characteristic of the entirety of the object cannot be found due to the object partially covered for some reason.

### BRIEF DESCRIPTION OF THE DRAWINGS

FIG. 1 is a block diagram showing the configuration of a face detection system;

FIG. 2 shows a process of multi-resolution conversion of an input image;

FIG. 3 is a block diagram showing the configuration of a detector;

FIG. 4 shows a procedure carried out in the detector;

FIG. 5 shows how characteristic quantities are calculated in a weak classifier;

FIG. 6 is a flow chart showing a learning method for the detector;

FIG. 7 shows a face sample image normalized so that eyes are located at predetermined positions therein;

FIG. 8 shows how histograms are generated from sample images;

FIG. 9 shows generation of occluded face sample images of which predetermined parts are occluded;

FIG. 10 shows examples of images representing occluded faces and detectors applicable to detection of the occluded faces;

FIG. 11 is a flow chart showing a procedure carried out in the face detection system; and

FIG. 12 shows switching of resolution-converted images as targets of face detection and movement of a sub-window therein.

### DESCRIPTION OF THE PREFERRED EMBODIMENT

Hereinafter, an embodiment of the present invention will be described next.

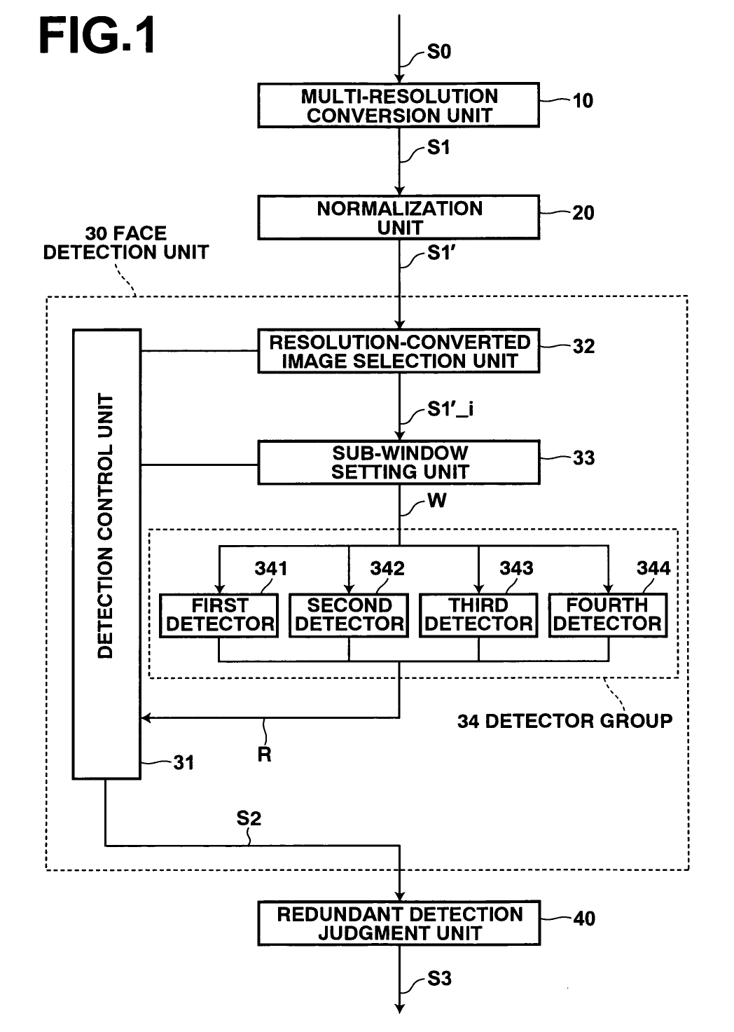

FIG. 1 is a block diagram showing the configuration of a face detection system 1 to which the object detection method of the present invention has been applied. The face detection system 1 detects a face included in a digital image, regardless of a position and a size thereof. As shown in FIG. 1, the face detection system 1 comprises a multi-resolution conversion unit 10, a normalization unit 20, a face detection unit 30, and a redundant detection judgment unit 40. The multi-resolution conversion unit 10 obtains a resolution-converted image group S1 (=S1_1, S1_2, . . . , S1_n) comprising images in different resolutions (hereinafter referred to as resolution-converted images) by carrying out multi-resolution conversion on an input image S0 to be subjected to face detection. The normalization unit 20 obtains a normalized resolution-converted image group S1′ (=S1′_1, S1′_2, . . . , S1′_n) by carrying out normalization on each of the resolution converted images in the resolution-converted image group S1 for converting pixel values so that the resolution-converted images become images of luminance gradation suitable for face detection processing that will be described later. The face detection unit 30 detects an image representing a face (hereinafter referred to as a face image S2) in each of the resolution-converted images in the image group S1′ by carrying out the face detection processing thereon. The redundant detection judgment unit 40 obtains a face image S3 without redundant face detection by judging whether the same face has been detected as the face images S2 in the resolution-converted images, based on a position thereof.

The multi-resolution conversion unit 10 obtains a normalized input image S0′ by normalizing the input image S0 into a predetermined resolution (image size) such as a rectangular image whose shorter sides respectively have 416 pixels, through conversion of the resolution of the input image S0. By further carrying out the resolution conversion on the normalized input image S0′, the multi-resolution conversion unit 10 generates the resolution-converted images in the different resolutions, for obtaining the resolution-converted image group S1. The resolution-converted image group S is generated for the following reason. A size of a face included in an input image is generally unknown. However, a size of face (image size) to be detected is fixed to a predetermined size, in relation to a detector generation method that will be described later. Therefore, in order to detect faces in various sizes, partial images of a predetermined size are cut sequentially in each of the resolution-converted images while positions of the partial images are shifted therein. Whether each of the partial images is a face image or a non-face image is then judged.

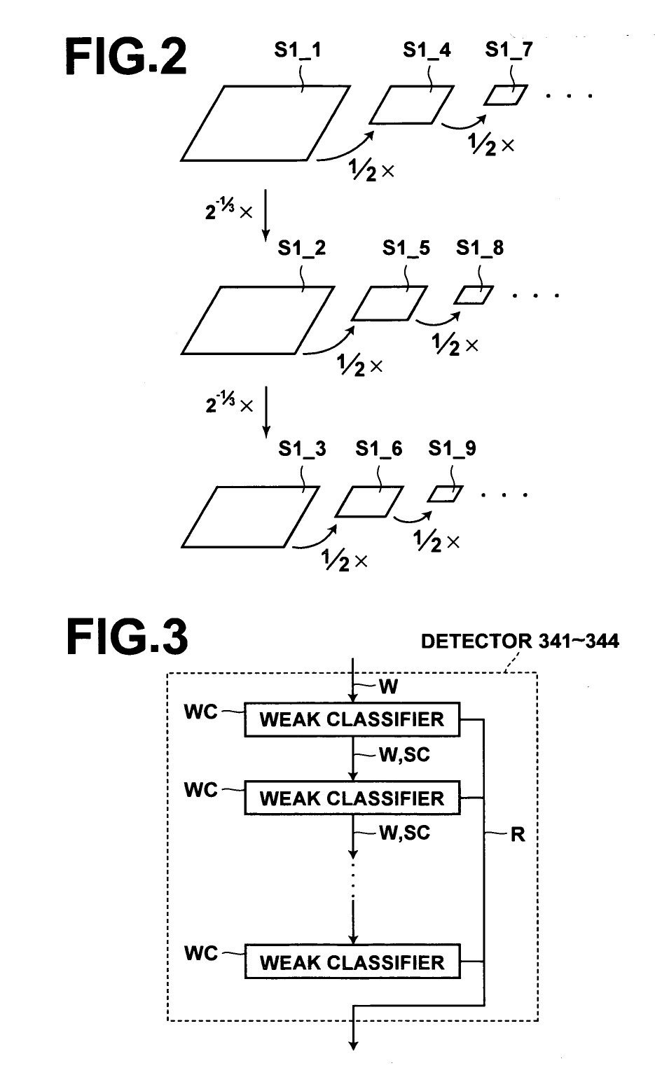

FIG. 2 shows a process of multi-resolution conversion of the input image (that is, generation of the resolution-converted image group S1). As shown in FIG. 2, the normalized input image S0′ is used as the resolution-converted image S1_1. Based on the resolution-converted image S1_1 is generated the resolution-converted image S1_2 in the size of 2 to the power of −⅓ of the resolution-converted image S1_1. Based on the resolution-converted image S1_2 is generated the resolution-converted image S1_3 in the size of 2 to the power of −⅓ of the resolution-converted image S1_2 (that is, in the size of 2 to the power of −⅔ of the resolution-converted image S1_1). The resolution-converted images S1_1 to S1_3 are respectively subjected to size reduction to ½, and images generated by the reduction are further reduced to ½. This procedure is repeated and the resolution-converted images are generated up to a predetermined quantity. In this manner, the images whose sizes have been reduced from the image S1_1 to every 2 to the power of −⅓ can be generated fast, mainly through the reduction to ½ that does not need interpolation of pixel values representing luminance. For example, in the case where the image S1_1 has the rectangular shape whose shorter sides respectively have 416 pixels, the resolution-converted images S1_2, S1_3 and so on have rectangular shapes whose shorter sides respectively have 330 pixels, 262 pixels, 208 pixels, 165 pixels, 131 pixels, 104 pixels, 82 pixels, 65 pixels, and so on. In this manner, the resolution-converted images reduced from the resolution-converted image S1_1 to every 2 to the power of −⅓ can be generated. The images generated without pixel value interpolation tend to keep characteristics of the original image. Therefore, accuracy improvement is expected in the face detection processing, which is preferable.

The normalization unit 20 carries out normalization processing on each of the images in the resolution-converted image group S1. More specifically, the normalization processing may be processing for converting the pixel values in the entire image according to a conversion curve (a look-up table) for causing the pixel values to be subjected to inverse Gamma transformation (that is, multiplication to the power of 2.2) in the sRGB color space followed by logarithmic conversion. This processing is carried out for the following reason.

An intensity I of light observed as an image is generally expressed as a product of a reflectance ratio R of a subject and an intensity L of a light source (that is, I=R×L). Therefore, the intensity I of the light changes with a change in the intensity L of the light source. However, the intensity I does not depend on the intensity L if the reflectance ratio R alone of the subject can be evaluated. In other words, face detection can be carried out with accuracy, without an effect of lightness of an image.

Let I1 and I2 denote intensities of light measured from parts of a subject whose reflectance ratios are R1 and R2, respectively. In log-log space, the following equation is derived:
Log(I1)−log(I2)=log(R1×L)−log(R2×L)
=log(R1)+log(L)−(log(R2)+log(L))=log(R1)−log(R2)=log(R1/R2)

In other words, carrying out logarithmic conversion on pixel values in an image is equivalent to conversion into a space wherein a ratio between reflectance ratios is expressed as a difference. In such a space, only the reflectance ratios of the subject, which are not dependent on the intensity L of the light source, can be evaluated. More specifically, contrast (the difference itself of the pixel values) that varies according to lightness in an image can be adjusted.

Meanwhile, an image obtained by a device such as a general digital camera is in the sRGB color space. The sRGB color space is an internationally standardized color space wherein hue, saturation and the like are defined for consolidating differences in color reproduction among devices. In this color space, pixel values are obtained by multiplying an input luminance value to the power of 1/γout (=0.45) in order to enable color reproduction appropriate for an image output device whose Gamma value (γout) is 2.2.

Therefore, by evaluating the difference between the pixel values at predetermined points in the image converted according to the conversion curve that causes the pixel values in the entire image to be subjected to the inverse Gamma transformation (that is, multiplication to the power of 2.2) followed by the logarithmic conversion, the reflectance ratios alone of the subject, which are not dependent on the intensity L of the light source, can be evaluated appropriately.

The face detection unit 30 carries out the face detection processing on each of the images in the resolution-converted image group S1′ having been subjected to the normalization processing carried out by the normalization unit 20, and detects the face image S2 in each of the resolution-converted images. The face detection unit 30 comprises a detection control unit 31, a resolution-converted image selection unit 32, a sub-window setting unit 33, and a detector group 34. The detection control unit 31 mainly carries out sequence control in the face detection processing by controlling each of the units. The resolution-converted image selection unit 32 sequentially selects from the resolution-converted image group S1′ one of the resolution-converted images in order of smaller size to be subjected to the face detection processing. The sub-window setting unit 33 sets a sub-window for cutting each partial image W as a target of judgment of face or non-face image in the resolution-converted image selected by the resolution-converted image selection unit 32 while sequentially changing a position of the sub-window. The detector group 34 comprises detectors that judge whether the partial image W having been cut is a face image.

The detection control unit 31 controls the resolution-converted image selection unit 32 and the sub-window setting unit 33 for carrying out the face detection processing on each of the images in the resolution-converted image group S1′. For example, the detection control unit 31 appropriately instructs the resolution-converted image selection unit 32 to select the resolution-converted image to be subjected to the processing and notifies the sub-window setting unit 33 of a condition of sub-window setting. The detection control unit 31 also outputs a result of the detection to the redundant detection judgment unit 40.

The resolution-converted image selection unit 32 sequentially selects the resolution-converted image to be subjected to the face detection processing in order of smaller size (that is, in order of coarse resolution) from the resolution-converted image group S1′, under control of the detection control unit 31. The method of face detection in this embodiment is a method of detecting a face in the input image S0 by judging whether each of the partial images W cut sequentially in the same size from each of the resolution-converted images is a face image. Therefore, the resolution-converted image selection unit 32 sets a size of face to be detected in the input image S0 at each time of detection, which is equivalent to changing the size of face to be detected from a larger size to a smaller size.

The sub-window setting unit 33 sequentially sets the sub-window according to the sub-window setting condition set by the detection control unit 31 in the resolution-converted image selected by the resolution-converted image selection unit 32 while sequentially moving the sub-window therein. For example, in the selected resolution-converted image, the sub-window setting unit 33 sequentially sets the sub-window for cutting the partial image W in the predetermined size (that is, 32×32 pixels) at a position on a line along which the resolution-converted image is scanned two-dimensionally, while rotating the resolution-converted image in 360 degrees in the plane of the image. The sub-window setting unit 33 outputs the partial image W to the detector group 34.

The detector group 34 comprises a plurality of detectors each of which judges whether the partial image W is an image representing a face in a predetermined state. More specifically, the detector group 34 comprises a first detector 341 for judging whether the image represents the entirety of a face, a second detector 342 for judging whether the image represents a right-occluded face wherein a part of the right side of a face is occluded, a third detector 343 for judging whether the image represents a left-occluded face wherein a part of the left side of a face is occluded, and a fourth detector 344 for judging whether the image represents a top-occluded face wherein a part of the upper side of a face is occluded, all of which are connected in parallel.

Each of the detectors calculates characteristic quantities related to difference values between the pixel values (luminance) at predetermined points, as at least one of characteristic quantities related to distribution of the pixel values in the partial image W. By using the characteristic quantities, each of the detectors judges whether the partial image W is a face image in the predetermined state.

Next are described the configuration of each of the detectors comprising the detector group 34, a flow of processing therein, and a learning method therefor.

FIG. 3 shows the configuration of the detectors. As shown in FIG. 3, each of the detectors comprises a plurality of weak classifiers WC. The weak classifiers WC are connected serially in order of effectiveness for the judgment, and have been selected from a plurality of weak classifiers through training that will be described later. Each of the weak classifiers WC calculates the characteristic quantities from the partial image W according to a predetermined algorithm specific thereto, and finds a score representing a probability of the partial image W being the face image in the corresponding predetermined state according to the characteristic quantities and a histogram thereof that will be described later. Each of the detectors 341 to 344 evaluates the scores obtained from all or a part of the weak classifiers WC, and obtains a result R representing whether the partial image W is a face image in the corresponding predetermined state.

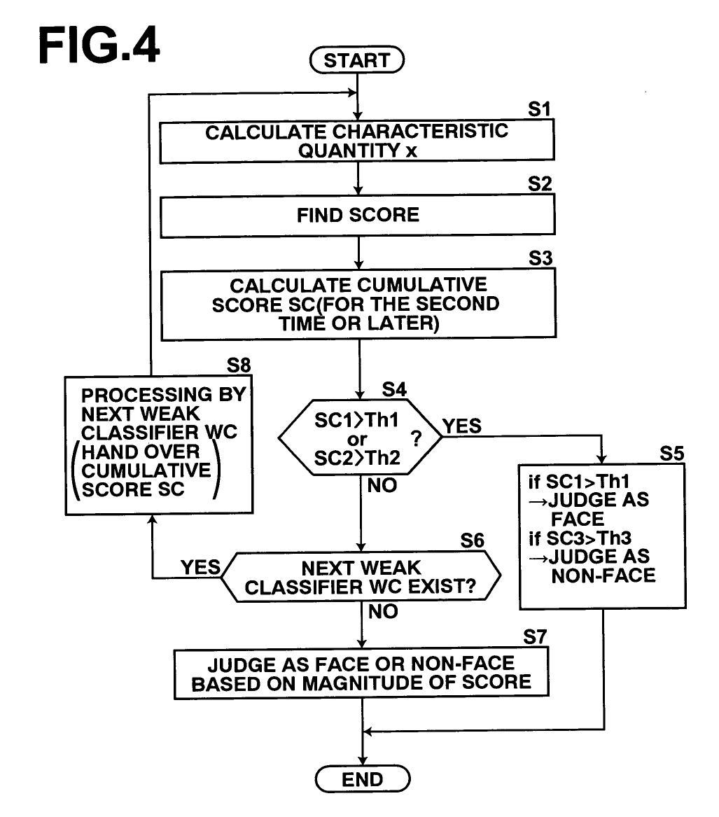

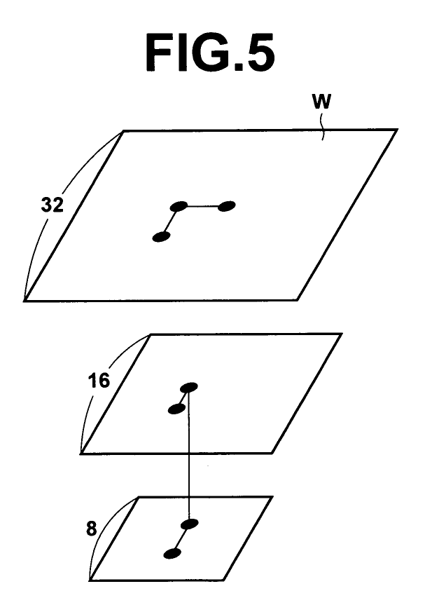

FIG. 4 is a flow chart showing a procedure carried out in one of the detectors. When the partial image W is input thereto, the first weak classifier WC calculates a characteristic quantity x (Step S1). For example, as shown in FIG. 5, the first weak classifier WC carries out 4-neighbor averaging on the partial image W of the predetermined size such as 32×32 pixels. The 4-neighbor averaging refers to processing wherein the image is divided into blocks of 2×2 pixels and a mean value of the values of the 4 pixels in each of the blocks is used as the pixel value corresponding to the block. In this manner, reduced images of 16×16 pixels and 8×8 pixels are obtained. Using two predetermined points set in a plane of each of the 3 images as one pair, the difference value in the pixel values (luminance) is calculated between the two points in each pair comprising one pair group, and a combination of the difference values is used as the characteristic quantities. The two predetermined points in each of the pairs are predetermined two points aligned vertically or horizontally in each of the images so as to reflect a characteristic of density of a face therein, for example. A value corresponding to the combination of the difference values (the characteristic quantities) is found as the characteristic quantity x. Based on the value x, a score is calculated that represents the probability of the partial image W being the face image to be detected thereby (such as the entirety of face for the detector 341 and the right-occluded face for the detector 342), based on the histogram (Step S2). A cumulative score SC is then calculated by adding the score to the score calculated by the preceding weak classifier (Step S3). Since the first weak classifier WC does not have the score fed thereto, the score calculated by the first weak classifier is used as the cumulative score as it is. Whether the cumulative score SC exceeds a predetermined threshold value Th1 and whether the cumulative score SC is smaller than a predetermined threshold value Th2 are judged (Step S4). In other words, whether the condition SC>Th1 or whether the condition SC<Th2 is satisfied is judged. The partial image W is judged to be the face image to be detected in the case where the condition SC>Th1 is satisfied, while the partial image W is judged to be a non-face image in the case where the condition SC<Th2 is satisfied. (Step S5). The procedure ends in these cases. In the case where the both conditions are not satisfied at Step S4, whether the next weak classifier exists is judged (Step S6). If a result of judgment at Step S6 is affirmative, the cumulative score is handed over to the next weak classifier WC for causing the next weak classifier to carry out the judgment (Step S8). If the result of the judgment at Step S6 is negative, the partial image W is judged to be either the face image or a non-face image based on magnitude of the cumulative score (Step S7) to end the procedure.

The method of training the detectors (the method of generating the detectors) is described next.

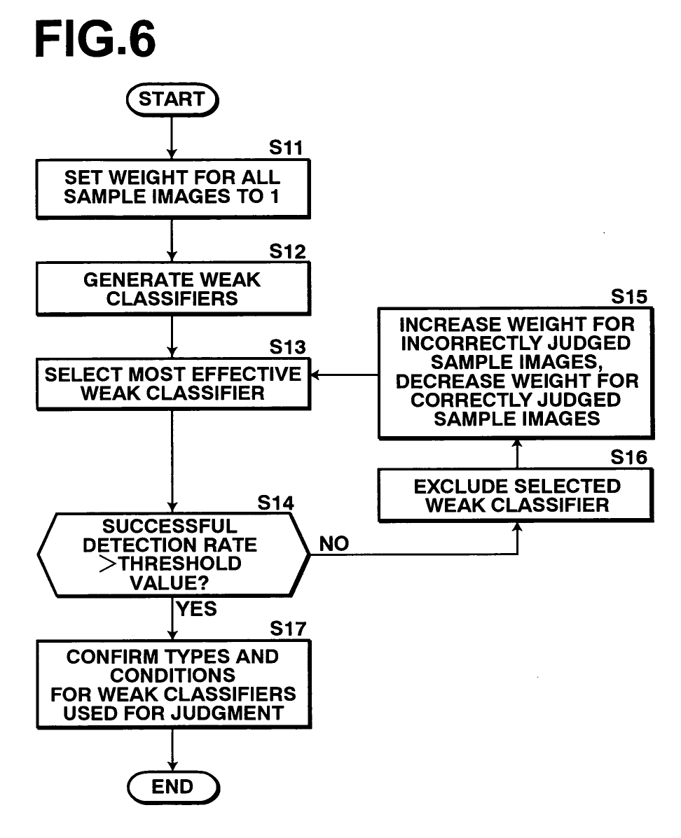

FIG. 6 is a flow chart showing the method of training. In the training of the detectors are used a plurality of sample images normalized to have a predetermined size (such as 32×32 pixels) and having been subjected to the same processing as the normalization processing carried out by the normalization unit 20. The sample images comprise a face sample image group including face sample images representing different faces and a non-face sample image group including sample images representing non-face subjects. For the face sample images, the faces represented therein are front-view faces, and the face orientations are substantially the same as the vertical direction of the images.

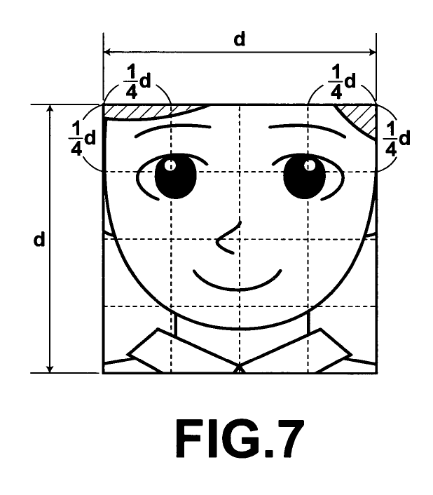

For each of the face sample images are used a plurality of variations obtained by scaling the vertical and/or horizontal side(s) thereof by a factor ranging from 0.7 to 1.2 in 0.1 increment followed by rotation thereof in 3-degree increment ranging from −15 degrees to +15 degrees in the plane thereof. A size and a position of the face therein are normalized so as to locate the eyes at predetermined positions, and the scaling and the rotation described above are carried out with reference to the positions of eyes. For example, in a face sample image of d×d pixels, the size and the position of the face are normalized so that the eyes can be located at positions d/4 inward from the upper left corner and the upper right corner of the image and d/4 downward therefrom, as shown in FIG. 7. At this time, the middle point between the eyes is used as the center of the scaling and the rotation.

A weight is assigned to each of the sample images comprising the face sample image group and the non-face sample image group. The weights for the respective sample images are initially set to 1 (Step S11).

The weak classifiers are generated for respective pair groups of a plurality of types, each of which uses as one pair the 2 predetermined points set in the planes of each of the sample images and the reduced images thereof (Step S12). Each of the weak classifiers provides a criterion for distinguishing a face image from a non-face image by using the combination of the pixel value (luminance) differences each of which is calculated between the 2 points comprising one of the pairs in one of the pair groups set in the planes of the partial image W cut by the sub-window and the reduced images thereof. In this embodiment, the histogram for the combination of the pixel-value differences is used as a basis for a score table for the corresponding weak classifier.

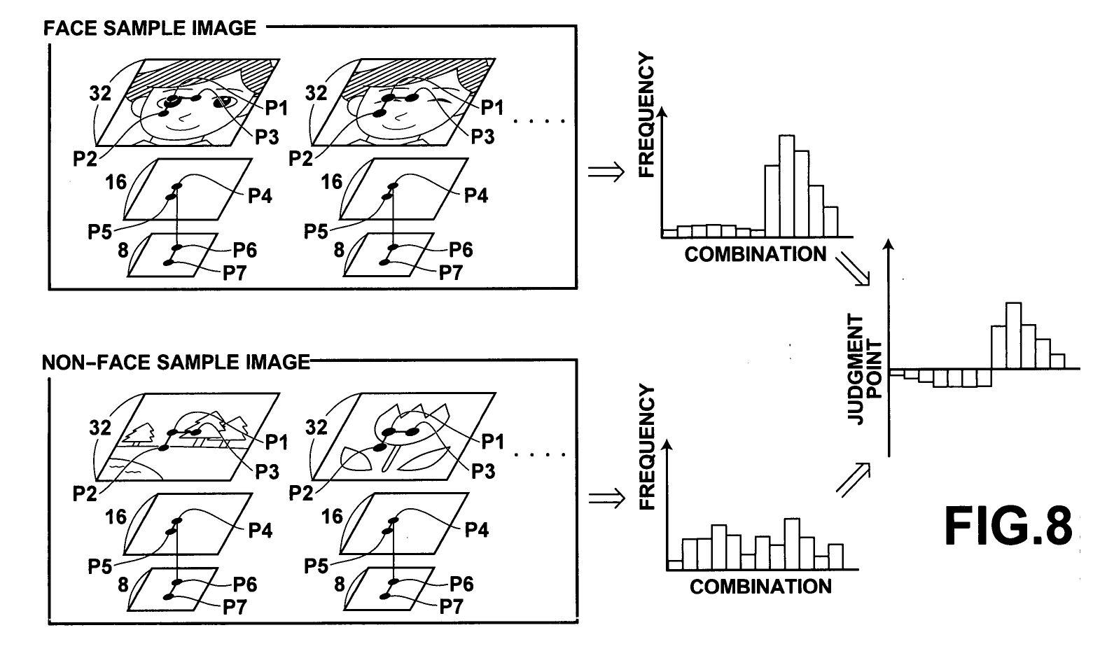

Generation of the histogram from the sample images is described below with reference to FIG. 8. As shown on the left side of FIG. 8, the 2 points comprising each of the pairs in one of the pair groups used for generation of the weak classifier are P1 and P2, P1 and P3, P4 and P5, P4 and P6, and P6 and P7. The point P1 is located at the center of the right eye in each of the face sample images while the point P2 is located in the right cheek therein. The point P3 is located between the eyebrows. The point P4 is located at the center of the right eye in the reduced image of 16×16 pixels generated through the 4-neighbor averaging of the corresponding sample image while the point P5 is located in the right cheek therein. The point P6 is located in the forehead in the reduced image of 8×8 pixels generated through further 4-neighbor averaging while the point P7 is located on the mouth therein. Coordinate positions of the 2 points comprising each of the pairs in one of the pair groups used for generation of the corresponding weak classifier are the same for all the sample images. For each of the face sample images, the combination of the pixel-value differences is found for the 5 pairs, and a histogram thereof is generated. The difference can take values of 65536 patterns in the case where the luminance is represented by 16-bit gradation. Therefore, although the combination of the differences depends on the number of luminance gradations, the whole combination of the differences can take patterns of 65536 to the power of 5, that is, the number of gradations to the power of the number of the pairs. Consequently, the training and the detection require a large amount of samples, time, and memory. For this reason, in this embodiment, the differences are divided into ranges of appropriate width and quantized into n-values (such as n=100). In this manner, the combination of the differences can take patterns of n to the power of 5, which can reduce data representing the combination.

Likewise, for the sample images representing non-face subjects, a histogram is generated. For the non-face sample images are used the same positions as the positions of the predetermined 2 points (represented by the same reference codes P1 to P7) in each of the pairs in each of the face sample images. A histogram is then generated by converting a ratio between frequency values represented by the 2 histograms into logarithm, which is shown on the right side of FIG. 8. This histogram is used as the basis for the score table for the weak classifier. The value of the vertical axis of the histogram is hereinafter referred to as a judgment point. According to this weak classifier, an image showing distribution of the combination of the differences corresponding to a positive judgment point has a high probability of representing a face, and the larger the absolute value of the judgment point, the higher the probability becomes. Likewise, an image showing distribution of the combination of the differences corresponding to a negative judgment point has a high probability of representing a non-face subject, and the larger the absolute value of the judgment point, the higher the probability becomes. At Step S12, each of the weak classifiers in the form of the histogram is generated for the combination of the pixel-value differences each of which is calculated between the 2 predetermined points in each of the pairs comprising each of the pair groups of the different types.

Among the weak classifiers generated at Step S12, the most effective classifier is selected for the judgment of a face or non-face image. This selection is carried out in consideration of the weight for each of the sample images. In this example, a weighted successful detection rate is examined for each of the weak classifiers, and the weak classifier achieving the highest detection rate is selected (Step S13). More specifically, the weight for each of the sample images is 1 at Step S13 carried out for the first time, and the most effective classifier is selected as the classifier having the largest number of sample images that have been judged correctly as the face images or the non-face images. At Step S13 carried out for the second time after Step S15 whereat the weight is updated for each of the sample images as will be described later, the sample images have the weights that are 1, larger than 1, and smaller than 1. The sample images whose weights are larger than 1 contribute more to evaluation of the successful detection rate than the sample images whose weights are 1. Therefore, at Step S13 carried out for the second time or later, correct judgment of the sample images of the larger weights is more important than correct judgment of the sample images of the smaller weights.

Judgment is then made as to whether a successful detection rate (that is, a rate of agreement of a detection result as to whether each of the sample images represents a face image or a non-face image with a correct answer) achieved by a combination of all the weak classifiers having been selected exceeds a predetermined threshold value (Step S14). At this training stage, the weak classifiers are not necessarily connected linearly. The sample images used for evaluation of the successful detection rate for the combination of the weak classifiers may be the sample images with the current weights or the sample images whose weights are the same. In the case where the rate exceeds the threshold value, the weak classifiers having been selected are sufficient for achieving a high probability of judgment of a face or non-face image. Therefore, the training is completed. In the case where the rate is equal to or smaller than the threshold value, the procedure goes to Step S16 for adding another one of the weak classifiers to be used in combination of the weak classifiers having been selected.

At Step S16, the weak classifier selected at the immediately preceding Step S13 is excluded so that the same weak classifier is not selected again.

The weights are then increased for the sample images that have not been judged correctly by the weak classifier selected at the immediately preceding Step S13 while the weights for the sample images having been judged correctly are decreased (Step S15). The weights are increased or decreased for enhancing an effect of the combination of the weak classifiers by putting emphasis on selecting the weak classifier enabling correct judgment on the images that have not been judged correctly by the weak classifiers having been selected.

The procedure then returns to Step S13 whereat the weak classifier that is the most effective among the remaining classifiers is selected with reference to the weighted successful detection rate.

If the successful detection rate confirmed at Step S14 exceeds the threshold value after selection of the weak classifier corresponding to the combination of the pixel-value differences each of which is calculated between the 2 predetermined points comprising each of the pairs in a specific one of the pair groups through repetition of the procedure from Step S13 to Step S16, the types of the weak classifiers used for the face detection and conditions therefor are confirmed (Step S17), and the training is completed. The selected weak classifiers are linearly connected in order of higher weighted successful detection rate, and the weak classifiers comprise one detector. For each of the weak classifiers, the score table therefor is generated based on the corresponding histogram, for calculating the score according to the combination of the pixel-value differences. The histogram itself may be used as the score table. In this case, the judgment point in the histogram is used as the score.

The detectors are generated through the training using the face sample image groups and the non-face sample image group. In order to generate the detectors corresponding to different states of faces to be judged, such as the first to fourth detectors 341 to 344 in the embodiment described above, face sample image groups respectively corresponding to the states of faces are prepared. The training is carried out regarding each type of the face sample image groups, by using each of the face sample image groups with the non-face sample image group.

In this embodiment are prepared an entirety face sample image group comprising entirety face sample images SN representing the entirety of faces, a right-occluded face sample image group comprising right-occluded face sample images SR representing faces whose right parts are covered, a left-occluded face sample image group comprising left-occluded face sample images SL representing faces whose left parts are covered, a top-occluded face sample image group comprising top-occluded face sample images SU representing faces whose upper parts are covered, and a bottom-occluded face sample image group comprising bottom-occluded face sample images representing faces whose lower parts are covered. The occluded face sample images representing faces of which predetermined parts are covered can be obtained by cutting the entirety face sample images with a frame having the same size as the entirety face sample images at positions shifted by a predetermined length in predetermined directions in the entirety face sample images.

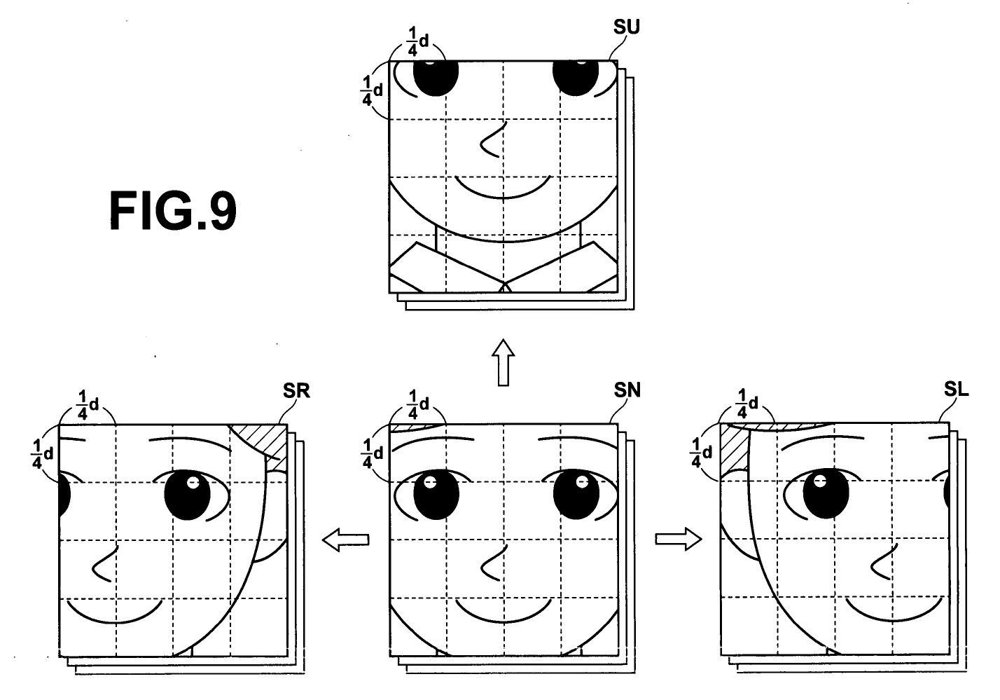

FIG. 9 shows how the occluded face sample images are obtained by cutting the entirety face sample images with the frame having the same size as the images at the positions shifted by the predetermined length in predetermined directions. As shown in FIG. 9, in order to obtain the right-occluded face sample images SR, each of the entirety face sample images SN is cut by the frame of the same size at a position shifted by d/4 to the right (that is, to the left side of the face in the corresponding sample image SN). In this manner, the right-occluded face sample images SR are obtained as the entirety face sample images whose ¼ of the entire region from the right eye to the outside is cut. Likewise, in order to obtain the left-occluded face sample images SL and the top-occluded face sample images SU, each of the entirety face sample images SN is cut by the frame of the same size at a position shifted by d/4 to the left (that is, to the right side of the face in the sample image SN) and at a position shifted by d/4 to the lower side. In this manner, the left-occluded face sample images SL and the top-occluded face sample images SU are obtained as the entirety face sample images whose ¼ of the region from the left eye to the outside is cut and as the entirety face sample images whose ¼ of the region from the eyes to the above is cut.

After the entirety face sample image group and the occluded face sample image groups are obtained, the training is carried out by using each of the face sample image groups together with the non-face sample image group, for generating the first to fourth detectors 341 to 344.

The second to fourth detectors 342 to 344 generated through the training using the occluded face sample image groups have learned the characteristics of the occluded faces. Therefore, judgment can be made thereby regarding an image partially representing a face that is difficult to detect for the first detector 341 which has only learned the characteristic of the entirety of the faces.

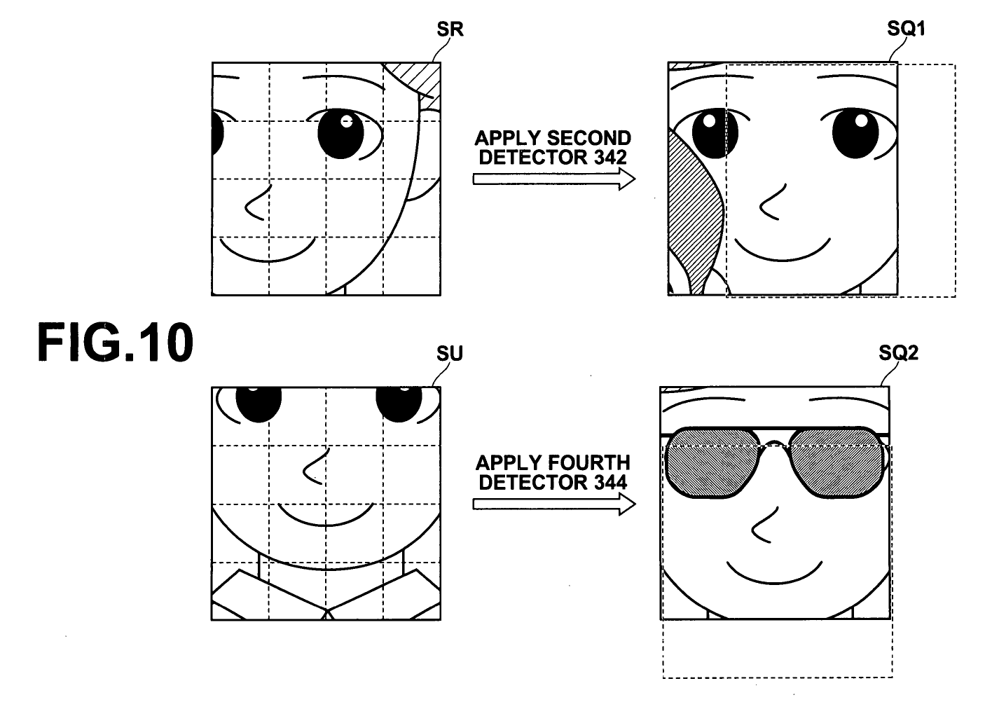

FIG. 10 shows examples of images representing occluded faces and the detectors suitable for detection of the faces. As shown in FIG. 10, for an image such as an image SQ1 wherein a characteristic of the right side of face cannot be sufficiently detected because the head of a person in a row in a class photo below the face to be detected covers the face on the right side thereof, for example, the face can be detected by the second detector 342 which has learned the sample images of faces whose right side is covered. For an image such as an image SQ2 wherein a characteristic of eyes cannot be sufficiently detected because of sunglasses, for example, the face can be detected by the fourth detector 344 which has learned the sample images of faces whose upper side is covered.

In the case where the learning method described above is adopted, the weak classifiers are not necessarily limited to the weak classifiers in the form of histograms, as long as the criteria for judgment of a face image or a non-face image can be provided by using the combination of the pixel-value differences each of which is calculated between the 2 predetermined points comprising each of the pairs in a specific one of the pair groups. For example, the weak classifiers may be in the form of binary data, threshold values, or functions. Even in the case where the form of histogram is used, a histogram showing distribution of the differences between the 2 histograms shown in the middle of FIG. 8 may be used instead.

The method of learning is not necessarily limited to the method described above, and another machine learning method such as a method using a neural network may also be used.

The redundant detection judgment unit 40 carries out processing for classifying the face images representing the same face in the images in the resolution-converted image group S1′ (that is, the face images detected more than once) into one face image according to position information on the true face images S2 detected by the face detection unit 30, and outputs the true face image S3 detected in the input image S0. The size of face detected by each of the detectors compared to the size of the partial image W has some margin although the margin depends on the learning method. Therefore, this processing is carried out because the images representing the same face are sometimes detected more than once in the resolution-converted images whose resolutions are close to each other.

In this embodiment, the sub-window setting unit 33 serves as the partial image cutting means and the detector group 34 serves as the judgment means of the present invention.

A procedure carried out in the face detection system 1 is described next.

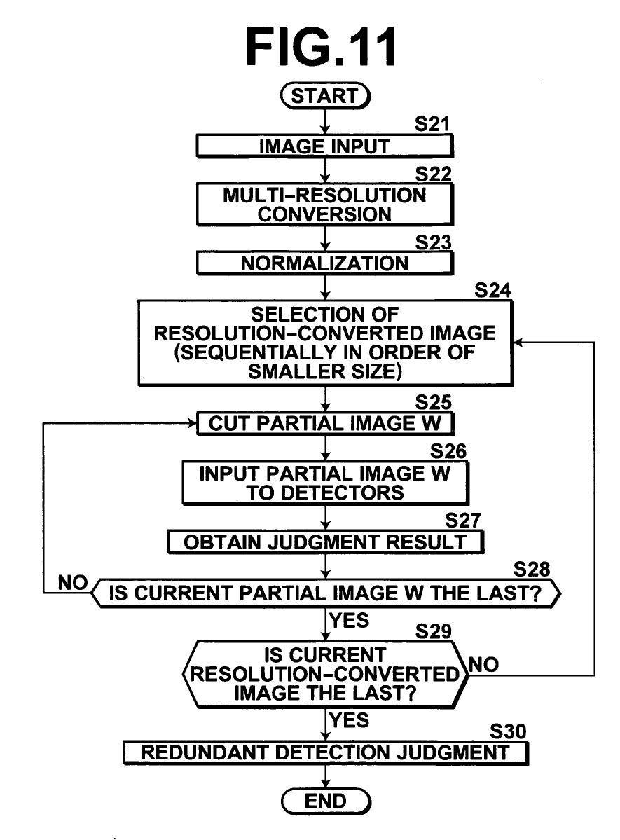

FIG. 11 is a flow chart showing the procedure. As shown in FIG. 11, the input image S0 is fed to the multi-resolution conversion unit 10 (Step S21), and the image S0′ is generated in the predetermined size converted from the size of the input image S0. The resolution-converted image group S1 is generated comprising the resolution-converted images having the sizes (resolutions) reduced to every 2 to the power of −⅓ from the image S0′ (Step S22). The normalization unit 20 carries out the normalization processing for reducing the variance of contrast in the resolution-converted images to obtain the normalized resolution-converted image group S1′ (Step S23). In the face detection unit 30, the resolution-converted image selection unit 32 instructed by the detection control unit 31 sequentially selects the resolution-converted image to be subjected to the face detection processing in order of smaller image size from the resolution-converted image group S1′. In other words, the resolution-converted image S1′_i is selected in order of S1′_n, S1′_n−1, . . . , and S1′_1 from the resolution-converted image group S1′ (Step S24). The detection control unit 31 sets the sub-window setting condition for the sub-window setting unit 33. In response, the sub-window setting unit 33 sets the sub-window in the resolution-converted image S1′_i while sequentially moving the sub-window for cutting the partial image W of the predetermined size (Step S25), and inputs the partial image W to the detector group 34 (Step S26). The detector group 34 judges whether the partial image W input thereto is an image of face in any one of the 4 states of occlusion, and the detection control unit 31 obtains the result R of the judgment (Step S27). The detection control unit 31 judges whether the partial image W currently cut is the partial image to be subjected last to the detection (Step S28). In the case where a result of the judgment is affirmative, the procedure goes to Step S29. Otherwise, the procedure returns to Step S25 for newly cutting the partial image W. In this manner, the face image in the resolution-converted image S1′_i is extracted.

After the detection is completed for the resolution-converted image S1′_i, the detection control unit 31 judges whether the resolution-converted image S1′_i currently selected is the image to be subjected last to the detection (Step S28). In the case where a result of the judgment is affirmative, the detection processing ends, and the redundant detection judgment is carried out (Step S29). Otherwise, the procedure returns to Step S24 whereat the resolution-converted image selection unit 32 selects the resolution-converted image S1′_i−1 whose size is larger than the currently selected resolution-converted image S1′_i by one step, for further carrying out the face detection.

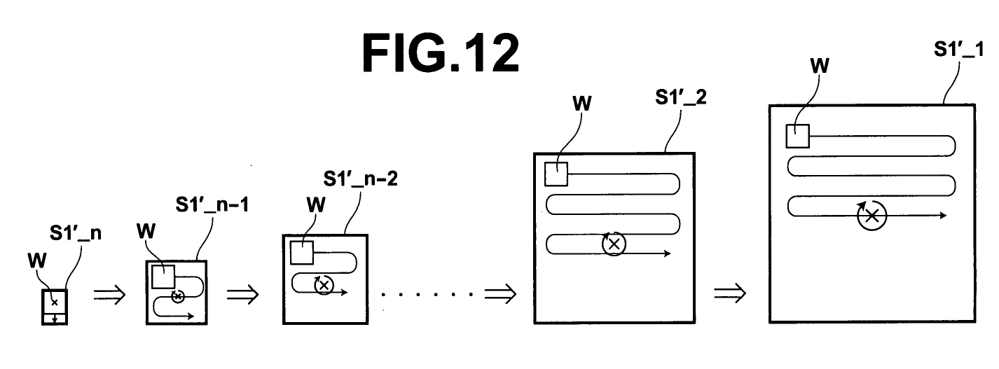

By repeating the procedure from Step S24 to Step S29 described above, the face image S2 can be detected in each of the resolution-converted images. FIG. 12 shows selection of the resolution-converted images in order of smaller size, and face detection is carried out therein.

At Step S30, the redundant detection judgment unit 40 classifies the face images S2 detected more than once into one face image, and the true face image S3 detected in the input image S0 is output.

As has been described above, according to the face detection system in the embodiment of the present invention, whether the partial image W cut from the input image represents a face is judged by using the detector (refereed to as the first detector) for which an image to detect represents an image of the entirety of face and by using the detectors (referred to as the second detectors) for which an image to detect represents an image of an occluded face. Therefore, even an occluded face that is difficult for the first detector to detect can be detected by the second detectors. Consequently, appropriate detection can be carried out even on a face that conventionally has not been judged due to lack of characteristic of the entirety of face caused by the face being covered for some reason.

Although the face detection system related to the embodiment of the present invention has been described above, a program for causing a computer to execute the procedure carried out by the face detection apparatus of the present invention in the face detection system is also an embodiment of the present invention. Furthermore, a computer-readable recording medium storing the program therein is also an embodiment of the present invention.

What is claimed is:

1. An object detection method for detecting a predetermined object in an input image, the method comprising the steps of:
preparing a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;
cutting partial images in the predetermined sizes at different positions in the input image; and
judging whether each of the partial images is an image representing the entirety of the predetermined object or whether each of the partial images is an image representing the predetermined object of which the predetermined part is covered, by applying at least one of the plurality of detectors on each of the partial images as the detection target image.

2. The object detection method according to claim 1, wherein the covered sample image group or groups is/are obtained by cutting each of the sample images in the entirety sample image group by a frame having the same size as the corresponding sample image at a position shifted by a predetermined length in a predetermined direction.

3. The object detection method according to claim 2, wherein the predetermined direction is either a horizontal or vertical direction of the sample images and the predetermined length ranges from ⅓ to ⅕ of a width of the predetermined object.

4. The object detection method according to claim 1, wherein the predetermined object is a face including eyes, nose, and mouth and the predetermined part is a part of the eyes or the mouth.

5. The object detection method according to claim 1, wherein the machine learning method is boosting.

6. An object detection apparatus for detecting a predetermined object in an input image, the apparatus comprising:
a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;
partial image cutting means for cutting partial images in the predetermined sizes at different positions in the input image; and
judgment means for judging whether each of the partial images is an image representing the entirety of the predetermined object or whether each of the partial images is an image representing the predetermined object of which the predetermined part is covered, by applying at least one of the plurality of detectors on each of the partial images as the detection target image.

7. The object detection apparatus according to claim 6, wherein the covered sample image group or groups is/are obtained by cutting each of the sample images in the entirety sample image group by a frame having the same size as the corresponding sample image at a position shifted by a predetermined length in a predetermined direction.

8. The object detection apparatus according to claim 7, wherein the predetermined direction is either a horizontal or vertical direction of the sample images and the predetermined length ranges from ⅓ to ⅕ of a width of the predetermined object.

9. The object detection apparatus according to claim 6, wherein the predetermined object is a face including eyes, nose, and mouth and the predetermined part is a part of the eyes or the mouth.

10. The object detection apparatus according to claim 6, wherein the machine learning method is boosting.

11. A program for detecting a predetermined object in an input image, the program causing a computer to function as:
a plurality of detectors comprising a detector for judging whether a detection target image is an image representing the entirety of the predetermined object and a detector or detectors of at least one type for judging whether a detection target image is an image representing the predetermined object of which a predetermined part is covered, by causing the plurality of detectors to learn according to a method of machine learning a characteristic of the predetermined object in respective sample image groups obtained to include an entirety sample image group comprising sample images representing the entirety of the predetermined object in predetermined different sizes and a covered sample image group or covered sample image groups of at least one type comprising sample images representing the predetermined object of which the predetermined part is covered;
partial image cutting means for cutting partial images in the predetermined sizes at different positions in the input image; and
judgment means for judging whether each of the partial images is an image representing the entirety of the predetermined object or whether each of the partial images is an image representing the predetermined object of which the predetermined part is covered, by applying at least one of the plurality of detectors on each of the partial images as the detection target image.

12. The program according to claim 11, wherein the covered sample image group or groups is/are obtained by cutting each of the sample images in the entirety sample image group by a frame having the same size as the corresponding sample image at a position shifted by a predetermined length in a predetermined direction.

13. The program according to claim 12, wherein the predetermined direction is either a horizontal or vertical direction of the sample images and the predetermined length ranges from ⅓ to ⅕ of a width of the predetermined object.

14. The program according to claim 11, wherein the predetermined object is a face including eyes, nose, and mouth and the predetermined part is a part of the eyes or the mouth.

15. The program according to claim 11, wherein the machine learning method is boosting.
